(19) United States
(12) Patent Application Publication
(10) Pub. No.: US 2022/0218070 A1
(43) Pub. Date: Jul. 14, 2022

(54) COMPOSITE MEMBRANE AND METHOD OF MAKING A COMPOSITE MEMBRANE

(71) Applicant: TROCELLEN ITALIA S.P.A., Caponago (MB) (IT)

(72) Inventor: Manuel GRAZIOTTIN, Montebelluna (TV) (IT)

(73) Assignee: TROCELLEN ITALIA S.P.A., Caponago (MB) (IT)

(21) Appl. No.: 17/604,576

(22) PCT Filed: May 22, 2020
(86) PCT No.: PCT/IB2020/054879

§ 371 Date: Oct. 18, 2021

(30) Foreign Application Priority Data
May 24, 2019 (IT) 102019000007204

(51) Int. Cl. A43B 17/00; A43B 17/10; B32B 3/26; B32B 5/06; B32B 5/24; B32B 7/022

(52) U.S. Cl. CPC A43B 17/006; B32B 2437/02; B32B 3/266; B32B 5/06; B32B 5/245; B32B 7/022; B32B 2307/302; B32B 2307/726; B32B 2266/08; B32B 2266/025; B32B 2307/72; B32B 2307/732; B32B 2262/0276; B32B 2264/108; A43B 17/10

(57) ABSTRACT

The present invention relates to a composite membrane for garment accessories or wearable item accessories and a method for making the composite membrane. In particular, the composite membrane includes a first layer having a first side and a second side opposite to one another and with a plurality of through-holes which extend between the first side and the second side; and a first plurality of fibers made of a thermo-conductive material and configured to convey moisture. The through-holes are engaged by first fibers of the plurality of fibers so as to form channels designed to convey a liquid from the first side to the second side.

### TECHNICAL SECTOR

The present invention relates to a composite membrane and a method of making a composite membrane. The composite membrane according to the present invention is particularly suitable for the manufacture of accessories for garments or accessories for wearable items, especially hygienic insoles for footwear.

### PRIOR ART

In the sector for the production of accessories for garments or more generally accessories for wearable items to be used during the practice of a sport or a dynamic activity, owing to their impact-cushioning properties for some time it has been known to use membranes of varying thickness and/or density made using expanded polymeric materials. In fact, these membranes are particularly suitable for the manufacture, for example, of padding, linings, foot supports, insoles and upper supports.

Membranes made using expanded polymeric materials have, in addition to their impact-cushioning properties, further mechanical characteristics, including lightness and thermo-formability, which make them particularly suitable for use in this application sector. Other characteristics of the membranes made of expanded polymeric materials are the high thermal insulation capacity.

In addition to the impact-cushioning capacity, in order to ensure a high degree of comfort for the user when used, one of the most important requirements in the sector for the production of garment accessories or wearable item accessories to be used during the practice of a sport or a dynamic activity is that of allowing the removal, from the user's body, of the moisture or heat produced during sweating and consequently helping maintain a comfortable body temperature. This requirement is important in particular in the production of arch supports, insoles, upper supports and padding for protective helmets.

In order to obtain the breathability of such membranes it is known nowadays to make them using open-cell polymeric materials.

These materials, however, have a short working life in particular when used to make arch supports and insoles.

In fact, the hydrolytic action of the moisture which permeates said materials, during and following use, causes the deterioration thereof.

Moreover, this type of material tends to become impregnated and to promote the spread of bacteria and, consequently, the formation of bad odors.

Furthermore, the use of closed-cell expanded polymeric materials is able to obtain products which are generally more durable, kept more easily clean and have improved impact-cushioning properties, but which are impermeable and therefore unable to dissipate the moisture generated by the user's body.

Therefore, there exists still nowadays a very important need for composite membranes which are able to provide an increasingly higher impact-cushioning capacity and, at the same time, have a suitable capacity to dissipate the heat and/or moisture produced by the user's body.

### SUMMARY

Therefore, the technical problem underlying the present invention is that of meeting this requirement, namely that of providing a membrane able to ensure the removal from the user's body of the moisture and the heat produced during sweating.

In order to solve this problem, a composite membrane, an accessory for garments or for wearable items, and a method of making the aforementioned membrane are provided, as described in the respective independent claims.

Secondary characteristics of the subject of the present invention are defined in the dependent claims. Said claims, as filed, are incorporated herein, for the purposes of specific reference.

The membrane according to the present invention is a composite membrane for garment accessories or accessories for wearable items which may comprise:
a first layer having a first side and a second side opposite to one another and crossed by a plurality of through-holes extending between said first side and said second side;
a first plurality of fibers made of a thermo-conductive material and configured to convey moisture;

wherein said through-holes are engaged by first fibers of said first plurality of fibers so as to form channels suitable for conveying a liquid from said first side to said second side.

The composite membrane according to the present invention may be able to convey the moisture inside the fibers of thermo-conductive material configured to absorb and attract moisture. In this way, therefore, the heat and sweat generated by the user's body are captured by the first fibers present inside the holes in the first layer of the membrane. Namely the first fibers attract inside the holes in the first layer of the membrane the heat and moisture produced by a user and convey them across the first layer; consequently, the surface of the membrane in the vicinity of the body of a user or in contact with the latter will be drier and more comfortable compared to conventional membranes.

According to one aspect of the present invention, the composite membrane may also comprise a second layer and a third layer which are thermo-conductive and configured to diffuse vapor or a liquid through them. The first layer may have the first side covered by said second layer and said second side may be covered by said third layer; where said second layer, said third layer and said first fibers may be configured and mutually positioned in such a way that a first end of said first fibers is in contact with said second layer and a second end of said first fibers is in contact with said third layer to form a thermal bridge and to convey moisture and/or liquid between said third layer and said second layer. In particular, the second layer may comprise second fibers of said first plurality of fibers or consist of said second fibers.

The third layer may also comprise third fibers of said first plurality of fibers or consist of said third fibers.

Moreover, according to another aspect, the second layer may comprise second fibers of said first plurality of fibers or consist of said second fibers and/or, similarly, said third layer comprises third fibers of said first plurality of fibers or consist of said third fibers. Namely, at least partially, the second layer and/or third layer may be made of the same material from which the first fibers present inside the holes in the first layer are made.

According to a further aspect, the second layer may have a content of second fibers greater than the content of third fibers of said third layer and than the content of first fibers engaging the through-holes, for generating an attraction of liquid towards said second layer. Advantageously, in this way a gradient for the capacity of attraction of the liquid and the heat is generated such that the liquid and heat are attracted by the third layer which, during use, will be suitably directed towards the user and from here, transferred to the second layer, through the first fibers present in the plurality of holes. By arranging, during use, said third layer in the vicinity of or in contact with the user's body it is therefore possible to improve the sensation of comfort, in particular so that there is a perception of dryness and a pleasant temperature is maintained.

Other aspects of the present invention may concern the materials from which said layers are made. In particular, the first layer is preferably made of closed-cell expanded polymeric material; while the second and third fibers, from which the second layer and third layer are respectively made, as well as the first fibers included inside the plurality of holes, may comprise polymeric fibers and/or polymeric fibers with added thermo-conductive active particles configured to attract moisture, such as volcanic sand or active carbons.

The present invention also relates to an accessory for garments or wearable items comprising such a composite membrane. Examples of accessories for garments or for wearable items which may be made with the composite membrane according to the present invention are insoles for footwear, padding and linings.

Finally, the present invention relates to a method of making said composite membrane. The method comprises the steps of: forming a first layer, having a first side and a second side opposite to one another and made of a closed-cell expanded polymeric material; making a plurality of through-holes through the first layer; and engaging said through-holes with first fibers made of a thermo-conductive material configured to convey moisture.

It can be understood how the formation of through-holes through the first layer and engaging said through-holes with the first fibers may be performed at the same time, for example by means of a needle-punching process, or on successive occasions. According to one aspect of the present method, a step may be provided for forming a second layer of second fibers made of a thermo-conductive material configured to convey moisture, and a step of covering the first side of the first layer with said second layer.

In particular, according to this aspect, the steps of forming a plurality of through-holes in the first layer and engaging said through-holes with said first fibers may be performed by needle-punching the second layer onto the first layer. Following needle-punching of the second layer onto the first layer, a third layer of third fibers made of thermo-conductive material configured to attract moisture in contact with the second side of the first layer may be formed. Advantageously the plurality of holes in the first layer and the third layer of the composite membrane may be made at the same time by means of the single needle-punching operation.

Further advantages, characteristic features and modes of use forming the subject of the present invention will become clear from the following detailed description of examples of embodiment thereof, provided by way of a non-limiting example.

### BRIEF DESCRIPTON OF THE DRAWINGS

An embodiment of the composite membrane according to the present invention is shown in the attached sets of drawings, in which:

FIG. 1 shows a schematic, cross-sectioned and partially exploded view of a composite membrane according to the present invention.

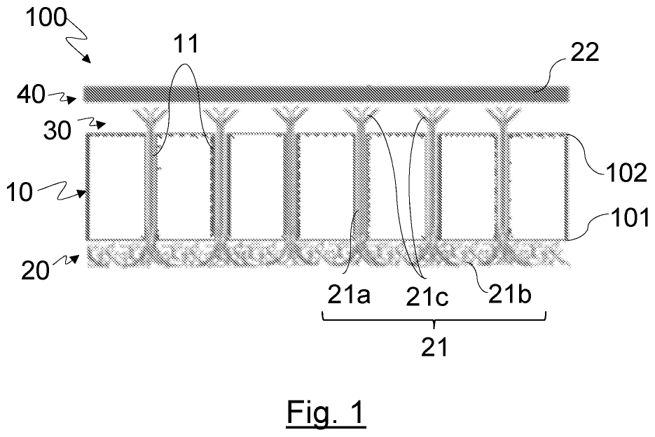

### DETAILED DESCRIPTION

With particular reference to the attached figure, in said figures 100 denotes overall a composite membrane for garment accessories or wearable item accessories according to the present invention.

“Composite membrane” is understood, in the context of the present invention, as meaning a membrane made of different materials, each of which is designed to perform a specific function.

The composite membrane 100 comprises a first layer 10, having a first side 101, or first surface, and a second side, or second surface 102, opposite one another. Said first layer 10 may be crossed by a plurality of through-holes 11, namely holes extending between the first side 101 and the second side 102 of the first layer 10. In other words, the first layer 10 may be a perforated layer in which one end of each hole 11 is located on the first side 101 and the other end of each hole 11 is located on the second side 102.

The composite membrane 110 may further comprise a first plurality of fibers 21 made of a thermo-conductive material and configured to convey moisture.

First fibers 21a of said first plurality of fibers 21 are contained inside the through-holes 11 of the first layer 10. Namely, said first fibers 21a of said first plurality of fibers 24 may engage or occupy the through-holes in the first layer 10, crossing therefore the first layer 10 from the first side 101 to the second side 102, so as to form channels designed to convey a liquid from said first side 101 to said second side 102, for example by means of capillarity. Expressed in other words, the holes 11 of the first layer 10 together with the first fibers 21a contained inside them may form channels for transferring a liquid for promoting the transmission of heat and/or moisture from the first side 101 to the second side 102 of the first layer 10.

Therefore, the heat and the sweat produced by a user when performing an activity, in particular a dynamic activity, are substantially attracted and channeled inside the holes 11 of the first layer 10 and consequently conveyed away from the surface of the first layer 10 which is placed in contact with, or in the proximity of, the user's body.

The composite membrane 100 may have a multilayer structure. In addition to the aforementioned first layer 10, the membrane 100 may further comprise a second layer 20 and a third layer 30. The first layer 10 is located in between the second layer 20 and the third layer 30; the first side 101 of the first layer 10 may be completely or partially covered by the second layer 20 which may be in contact substantially with the whole of the first side 101 or with a portion thereof, so as to diffuse onto it heat and/or moisture.

The second side 102 may be completely or partially covered by the third layer 30 which may be in contact substantially with the whole of the second side 101 or with a portion thereof, so as to diffuse onto it heat and/or moisture.

The second layer 20 and/or third layer 30, preferably both of them, may be thermo-conductive layers and configured to spread vapor or liquids through them. In particular, said second layer 20, said third layer 30 and said first fibers 21a may be configured and mutually positioned in such a way that a first end of said first fibers 21a is in contact with the second layer 20 and a second end of said first fibers 21a is in contact with the third layer 30. More specifically, the contact between the first fibers 21 and the second layer 21 and third layer 30 may be such as to facilitate the transfer of liquid between the second layer 20 and the third layer 30 and the formation of a thermal bridge between the latter, namely generate a region of the membrane 100 in which the thermal flow between the second layer 20 and the third layer 30 is facilitated.

The second layer 20 may comprise second fibers 21b of said first plurality of fibers 21, or may consist of said second fibers 21b, and/or similarly the third layer 30 may comprise third fibers 21c of said first plurality of fibers 21 or consist of said third fibers 21c. Therefore, both the second layer 20 and the third layer 30 may be made at least partially of the same thermo-conductive material and configured to convey moisture from or towards the first fibers 21a contained inside the holes 11 of the first layer 10. Preferably, a part of the second fibers 21b of the second layer 20 is braided or intertwined with or twisted onto a part of the first fibers 21a contained inside the holes 11 and/or a part of the third fibers 21c of the third layer 30 is braided or intertwined with a part of the first fibers 21a contained inside the holes 11. Alternatively, the second fibers 21b of the second layer 20 and/or the third fibers 21c of the third layer 30 are integral with the first fibers 21a. The intertwining or the integrality between the third fibers 21c of the third layer 30 and the first fibers 21a contained inside the holes 11 and/or the intertwining or the integrality of the latter with the second fibers 21b of the second layer 20 favors further transfer of the moisture, for example by means capillarity, between the third layer 30 and the second layer 20.

In this connection, the second layer 20 is more hygroscopic than said third layer 30.

According to one aspect of the present invention, the second layer 20 may have a content of second fibers 21b greater than the content of the third fibers 21c of said third layer 30 and than the content of first fibers 21a engaging the through-holes 11. The different content of fibers 21 between the different layers of the membrane 100 generates a gradient for the capacity to transmit heat and absorb and convey liquid from the layer with lesser fiber content to the layer with a greater fiber content, passing via the first fibers 21a contained inside the through-holes 11.

As a result, during use, the heat and the liquid from the third layer 30 flow towards the second layer 20. The layer with a lesser fiber content, namely the third layer 30, will be suitably directed towards or placed in contact with the user's body.

In this way, said third layer 30 exerts an action which removes the moisture and heat from the user's body, resulting in a pleasing sensation of freshness and dryness for the user.

In detail, the moisture produced by the user's body will tend gradually to be diffused through the third layer 30 which, in particular, may be configured to promote this diffusion effect.

Equally well, the third fibers 21c of the third layer 30 will diffuse the heat through the said third layer.

In this way, heat and moisture will be diffused in particular towards the first fibers 21a and, from these, will be diffused into the second layer 20, through the first layer 10.

The heat and the moisture flow through the channels formed by the holes 11 comprising the first fibers 21a towards the layer with a greater content of fibers, namely the second layer 20, which is coupled with the first side 102 of the first layer 10, opposite to the second side 102 of the first layer 10, with which instead said third layer 30 is coupled. In other words, there is a tendency to move the heat and moisture away from the user's body, favoring therefore the sensation of freshness and dryness.

The first layer 10 may be made of closed-cell or open-cell expanded polymeric material.

A closed-cell material will be chosen in those embodiments of the present invention where the main requirement is that of heat insulation and impact cushioning, durability or impermeability as opposed to breathability.

On the other hand, where the main requirement is that of optimizing the breathability, the first layer may be made of an open-cell expanded polymeric material, the intrinsic breathability of which will be greatly increased by the presence of the holes 11 engaged by the first fibers 21a.

Also, where a high degree of softness and/or elasticity of the composite membrane is required, in any case combined with durability and capacity to prevent the formation of bad odors, the first layer may be made of an open-cell expanded polymeric material where the first side 101 and/or the second side 102 may be lined with an impermeable film.

It can be understood how a composite membrane, according to the present invention, may be composed of a plurality of first layers as described above, each chosen so as to provide the manufactured item with the aforementioned properties depending on its structure.

The choice of a closed-cell expanded polymeric material for the first layer 10 also results in a high thermo-formability, which facilitates and reduces the cost of the manufacture of accessories for garments and wearable items with complex and ergonomic forms, and lightness, which makes the wearing of the garment or the article comprising an accessory made using the membrane according to the present invention more comfortable. The first layer 10 may be made of a polyolefinic crosslinked expanded foam, such as a crosslinked expanded foam based on polyethylene, polypropylene or a mixture based on ethylene vinyl acetate (EVA). In one embodiment, the first layer 10 may be made of crosslinked expanded polyethylene foam and has a density of between 20 kg/m³ and 800 kg/m³ or between 25 kg/m³ and 600 kg/m³ or between 30 kg/m³ and 180 kg/m³ or between 50 and 130 kg/m³.

These densities are suitable for the manufacture of insoles for footwear, but also for padding, for example for the shoulders, elbows and knees. More specifically, a density of 115 kg/m³ is preferable, in particular for the production of hygienic insoles for footwear.

Irrespective as to the type of material used for the manufacture of the first layer 10, it may have in particular a thickness of between 0.2 mm and 20 mm or between 2 mm and 8 mm, in particular a thickness of 5 mm. In this way, the accessory, such a padding or insole for footwear, made using the composite membrane 100 according to the present invention, occupies a small volume and may be removed or extracted from the garment or wearable item in a simple manner, thus facilitating the operations of cleaning the accessory itself and/or the garment or wearable item, of which it forms part.

Moreover, it is preferable that the plurality of through-holes 11 of the first layer 10 should have a density of between 10 and 60 holes/cm², so as to not to affect excessively the rigidity and impact-cushioning capacity of the membrane 100, while providing it with a homogeneous breathability and increasing it where the material from which the first layer 10 is made is already breathable. The plurality of holes 11 may have a density of 37 holes/cm²; this density is particularly recommended for a membrane 100, according to the present invention, which is designed for the manufacture of hygienic insoles for footwear. Moreover, the holes are preferably distributed uniformly across the first layer 10 so as to favor an equally uniform transfer of the heat and liquid from the third layer 30 to the second layer 20.

It can be understood how, in alternative embodiments of the invention, the holes may be more concentrated in zones where it is required to remove a greater quantity of heat and/or moisture and more spread out where a greater structural strength or a greater impact-cushioning capacity is required.

A further aspect of the membrane 100 according to the present invention concerns the composition of the first plurality of fibers 21 which may be made of thermo-conductive material and configured to convey moisture. According to this aspect, said first plurality of fibers 21 may comprise polymeric fibers and/or polymeric fibers with added thermo-conductive active particles configured to attract moisture. In the context of the present invention, “polymeric fibers with added active particles” is understood as meaning that said polymeric fibers are treated so as to retain for a long time inside them, mainly on their outer surface, thermo-conductive active particles designed to attract moisture.

The polymeric fibers with added particles may have a porous structure and/or internal channels determined by the presence of the active particles which may also be included or incorporated in the said fibers.

More specifically, said particles designed to attract moisture are particles, for example comprising volcanic sand and especially zeolite and/or active carbon, which have an outer surface with a micro porosity inside which molecules of water in liquid or gaseous form are attracted and retained.

In one embodiment, said first plurality of fibers 21 may contain polyester fibers which may be present in an amount equal to 50% and fibers added with active particles comprising volcanic sand and/or active carbon which may be present in an amount equal to 50%. Examples of a material which may be used in this way are described in the U.S. Pat. Nos. 7,850,766, 7,247,374, 6,998,155 and 6,844,122.

Finally, the composite membrane 100 may also comprise a fourth layer 40 coupled with said third layer 30.

The fourth layer 40 may cover said third layer 30 so that the third layer 30 is arranged between the fourth layer 40 and the first layer 10. Therefore, when the composite membrane 100 is in use, the fourth layer 40 is located directed towards the user's body or is located in contact therewith. Like the second layer 20 and the third layer 30, the fourth layer 40 may consist of a second plurality of fibers 22 made of thermo-conductive material and configured to convey moisture.

The second plurality of fibers 22 may also comprise, in turn, polymeric fibers and/or polymeric fibers with added thermo-conductive active particles configured to attract moisture. However, preferably, the fourth layer 40 has a smaller content of polymeric fibers with added particles or generally a smaller content of added particles than the second layer 20 and the third layer 30.

Therefore, between the fourth layer 40 and the third layer 30 there is created a thermal bridge, namely a region of the membrane 100 in which the thermal flow is facilitated, and a gradient for the liquid conveying capacity such as to facilitate the transfer of the liquid from the fourth layer 40 to the third layer 30.

Moreover the fourth layer 40 may have a distribution of the fibers 22 which is more uniform than that of the third layer 30. Consequently, the heat and vapor are absorbed more uniformly along said fourth layer 40 and transferred to the third layer 30.

The present invention also relates to an accessory for garments or wearable items comprising the composite membrane 100 as described above. Some possible examples of accessories for garments or for wearable items which may be made with the composite membrane according to the present invention are upper portions, insoles for footwear, padding and linings.

The present invention relates finally to a method of making a composite membrane 100, as described in detail hitherto. In the description of this method, elements and materials of the composite membrane 100 involved in the method and having the same function and the same structure as the elements and the materials of the invention as described above retain the same reference number and are not described again in detail.

The method of making a membrane 100 according to the present invention comprises the following steps:
forming a first layer 10 having a first side 101 and a second side 102 opposite to one another and made of a closed-cell expanded polymeric material;
making a plurality of through-holes 11 in the first layer 10;
engaging said through-holes 11 with first fibers 21a of a first plurality of fibers 21 made of a thermo-conductive material configured to convey moisture; In particular, the method may envisage:
forming a second layer 20 made of a thermo-conductive fibrous material configured to convey moisture; and
covering the first side 101 of the first layer 10 with said second layer 20.

This step of covering the first side 101 may involve the first side 101 of the first layer 10 bring completely or partially covered by the second layer 20 which may therefore be in contact substantially with the whole of the first side 101 or with a portion thereof, so as to diffuse over it heat and/or moisture in a uniform or localized manner, respectively.

Even more particularly, the steps of forming a plurality of through-holes 11 in the first layer 10 and engaging said through-holes 11 with first fibers 21a of the first plurality of fibers 21 are performed by needle-punching the second layer 20 onto the first layer 10.

According to said embodiment of the method, following needle-punching of the second layer 20 onto the first layer 10, a third layer 30, which may be placed in contact with the second side 102 of the first layer 10, may be formed.

The third layer 30 may be made using third fibers 21c made of thermo-conductive material configured to convey and attract moisture.

It will therefore be understood that, preferably, said first fibers 21a, said second fibers 21b and said third fibers 21c belong to the same first plurality of fibers 21.

The second side 102 may be completely or partially covered by the third layer 30 which may be in contact substantially with the whole of the second side 101 or with a portion thereof, so as to diffuse over it heat and/or moisture.

As known per se, needle-punching is a machining technique which consists in interlacing superimposed layers by means of punching with needles which introduce a fibrous material into the holes. The interlacing in fact is performed by means of a plurality of needles which move so as to cross transversely first a layer of fibrous material and then a second layer.

In this case, therefore, interlacing is performed by means of a plurality of needles which move firstly through the second layer 20 and then through the first layer 10. During said step, by means of the penetration of needles through the second layer 20 and the first layer 10, the plurality of holes 11 is therefore formed in the latter. Moreover, as a result of the action of the needles, some of the second fibers 21b of the second layer 20 are conveyed by the same needles so that they penetrate inside the first layer 10 and are bonded together with the latter. In other words, said first fibers 21a may form an integral part of said second fibers 21b.

In addition, at least some of the ends of the first fibers 21a project from the second side 102 of the first layer 10. Namely, a part of the second fibers 21b of the second layer 20 conveyed by the movement of the needles may be made to project outside the end of the holes in the second side 102 of the first layer 10 so as to form the third layer 30.

The part of the second fibers 21b of the second layer 20 conveyed by the movement of the needles which projects from the second side 102 of the first layer 10 may therefore form said third fibers 21c in which case the third layer 30 will therefore be formed, at least partly, by the same first fibers 21a.

Preferably, the needle-punching is performed using a density of needles of between 10 and 60 needles/cm², even more preferably with a density equal to 37 needles/cm².

Finally, the method of making a membrane 100 according to the present invention may also comprise a step which consists in mounting, on top of the third layer 30, a fourth layer 40 composed of a second plurality of fibers 24 made of a thermo-conductive material and configured to convey moisture.

The fourth layer 40 has the function of attracting heat and moisture and transferring them in a uniform manner to the third layer 30.

The fibers of the second plurality of fibers 24 may be equal to those of the first plurality of fibers 21.

The composite membrane 100 thus obtained may therefore be thermoformed so as to assume the form or shape of an accessory for a garment or a wearable item, such as a hygienic insole.

1. A composite membrane for garment accessories or accessories for wearable items comprising:
a first layer having a first side and a second side opposite to one another and crossed by a plurality of through-holes extending between said first side and said second side, and
a first plurality of fibers made of a thermo-conductive material and configured to convey moisture,
wherein said through-holes are engaged by first fibers of said first plurality of fibers so as to form channels suitable for conveying liquid or diffusing vapor from said first side to said second side.

2. The composite membrane according to claim 1, further comprising a second layer and a third layer, which layers are heat-conducting and configured to diffuse vapor or a liquid through them; wherein said first layer has said second side covered by said third layer and said first side covered by said second layer; where said second layer, said third layer and said first fibers are configured and mutually positioned in such a way that a first end of said first fibers is in contact with said second layer and a second end of said first fibers is in contact with said third layer to form a thermal bridge between said third layer and said second layer and to convey liquid between said third layer and said second layer.

3. The composite membrane according to claim 2, wherein said second layer comprises second fibers of said first plurality of fibers, or consists of said second fibers, and/or said third layer comprises third fibers of said first plurality of fibers, or consists of said third fibers.

4. The composite membrane according to claim 3, wherein the second fibers of the second layer and/or the third fibers of the third layer are integral with the first fibers or wherein a part of the second fibers of the second layer is braided or intertwined with or twisted onto a part of the first fibers and/or a part of the third fibers of the third layer is braided or intertwined with or twisted onto a part of the first fibers.

5. The composite membrane according to claim 2, wherein said second layer is more hygroscopic than said third layer.

6. The composite membrane according to claim 3, wherein said second layer has a content of second fibers greater than the content of third fibers of said third layer and greater than the content of first fibers engaging the through-holes, for generating an attraction of liquid towards said second layer.

7. The composite membrane according to claim 6, further comprising a fourth layer coupled with said third layer and, in turn, comprising a second plurality of fibers made of a thermo-conductive material and configured to convey moisture and wherein said fourth layer has a higher fiber content than the content of third fibers of said third layer.

8. The composite membrane according to claim 1, wherein the plurality of through-holes has a density of between 10 holes/cm² and 60 holes/cm², or equal to 37 holes/cm².

9. The composite membrane according to claim 1, wherein the first layer is made of closed-cell expanded polymeric material.

10. The composite membrane according to claim 9, wherein the first layer is made of polyolefinic cross-linked expanded foam.

11. The composite membrane according to claim 10, wherein the first layer is made of cross-linked expanded polyethylene foam.

12. The composite membrane according to claim 11, wherein the first layer has a density of between 20 kg/m³ and 800 kg/m³ or between 25 kg/m³ and 600 kg/m³ or between 30 kg/m³ and 180 kg/m³ or between 50 and 130 kg/m³, or is equal to 115 kg/m³.

13. The composite membrane according to claim 1, wherein the first layer has a thickness of between 0.2 mm and 20 mm or between 2 and 8 mm, or equal to 5 mm.

14. The composite membrane according to claim 1, wherein said first plurality of fibers comprises polymeric fibers and/or polymeric fibers with added thermo-conductive active particles configured to attract moisture.

15. The composite membrane according to claim 3, wherein said plurality of fibers have added thermo-conductive active particles configured to attract moisture, where the second fibers of said second layer have a mass content of said particles greater than that of the third fibers of said third layer.

16. The composite membrane according to claim 14, wherein said plurality of fibers contains polyester fibers, optionally in an amount equal to 50%, and/or fibers with added active particles which optionally comprise volcanic sand and/or activated carbon, optionally in an amount equal to 50%.

17. An accessory for a garment or wearable item, comprising a composite membrane according to claim 1.

18. A method of making a composite membrane according to claim 1, comprising the steps of:
forming a first layer, having a first side and a second side opposite to one another and made of a closed-cell expanded polymeric material,
making a plurality of through-holes in the first layer,
engaging said through-holes with first fibers of a first plurality of fibers made of a thermo-conductive material configured to convey moisture.

19. The method of making a composite membrane according to claim 18, comprising the steps of:
forming a second layer of said second fibers made of a thermo-conductive material configured to convey moisture, and
covering the first side of the first layer with said second layer.

20. The method of making a composite membrane according to claim 18, wherein the steps of making a plurality of through-holes in the first layer and of engaging said through-holes with said first fibers are realized by needle-punching the second layer onto the first layer.

21. The method of making a composite membrane according to claim 20, wherein after needle-punching the second layer onto the first layer a third layer of said third fibers, made of thermo-conductive material and configured to attract moisture in contact with the second side of the first layer is formed.

22. The method of making a composite membrane according to claim 20, wherein the needle-punching is carried out with a needle density of between 10 needles/cm² and 60 needles/cm², or with a density equal to 37 needles/cm².

23. The method of making a composite membrane according to claim 20 comprising the step of mounting, on top of the third layer, said fourth layer composed of a second plurality of fibers made of a thermo-conductive material and configured to convey moisture, for transferring heat and moisture to said third layer.
